(19) United States
(12) Patent Application Publication
(10) Pub. No.: US 2013/0347130 A1
(43) Pub. Date: Dec. 26, 2013

(54) METHODS AND APPARATUS FOR DYNAMICALLY PROVIDING MODIFIED VERSIONS OF ELECTRONIC DEVICE APPLICATIONS

(71) Applicant: BLUEBOX, San Francisco, CA (US)

(72) Inventor: Caleb Sima, San Francisco, CA (US)

(21) Appl. No.: 13/912,325

(22) Filed: Jun. 7, 2013

Related U.S. Application Data
(60) Provisional application No. 61/657,722, filed on Jun. 8, 2012.

(51) Int. Cl. G06F 21/62

(52) U.S. Cl. CPC G06F 21/6209
USPC 726/29

(57) ABSTRACT

A computer-implemented method for dynamically delivering a securitized version of an application to a mobile device in a computing system programmed to perform the method includes receiving a request for the application from a mobile device; sending the request for the application to an application server, receiving the application from the application server in response to the request for the application, determining with the computing system, a securitized version of the original requested application, and sending the securitized version of the application to the mobile device. In the invention, if the securitized version is not previously held in storage by the computing device, the computing device creates the securitized version and sends that to the mobile device.

### CROSS-REFERENCES TO RELATED APPLICATIONS

The present application is a continuation of provisional Application No. 61/657,722; filed on Jun. 8, 2012, the full disclosures of which is incorporated herein by reference.

### FIELD OF THE INVENTION

The present invention concerns the transfer of a program from a centralized location to a computer or computing system. More particularly the present invention concerns devices and methods for providing to a computer, particularly mobile computing devices, a secure version of a typically small, specialized program called an application or app.

### BACKGROUND OF THE INVENTION

With the advent of small mobile electronic devices, such as mobile telephones, now called smart phones, e-tablets, including those from Apple, Microsoft, Google, Amazon and others also arrived the small-specialized programs often referred to as an Application or App for short. There are applications for almost any function that can be imagined, including games, utilities, financial programs and connectivity programs as well as fun add-ons that help to pass the time. These applications are often sold through on-line application stores that can be accessed either directly from the device or via an Internet browser, either within the device or elsewhere with connectivity to the device.

However, as with any computer system or device connected to a network and/or the Internet, these applications are potential carriers of any type of insidious programs such as viruses and tracking software, among others. Or these applications are constructed in a manner that does not adhere to secure application programming guidelines, wherein their usage may conflict with an organization's security requirements or policies. As a result many corporations and government offices that provide smart telephones or other portable electronic devices to employees and others have prohibited and in many cases through the use of administrative properties of the devices barred the devices from accepting applications. As many of these devices not only provide mobile communications and functionality but also are connected to the networks and servers of companies and government computer systems, applications having this insecurity property are a threat to the security of client data, company systems and data, government records and even national security.

It is understood that many applications provide clever functionality and are useful for business and, among other things, travel assistance, reservations, tracking of flights and analysis of data as well, boarding passes for airlines are now available through such devices, and would be helpful to the users of these devices to install and use. Further, companies that produce such useful applications for sale through the on-line and direct stores are finding that sales of these apps are compromised by the lack of security that purchasers may have when deciding to purchase the apps. This lack of security can be crippling to an application producer and can therefore have deleterious effects on commerce and the survivability of application business.

It would be desirable, therefore to offer reliable, safe and secure choices to application users and writers such that an application can be downloaded to a device without having a damaging effect on the device or the systems to which it is or may be connected or which are otherwise prohibited due to security protocols and safety considerations.

### SUMMARY OF THE INVENTION

In accordance with the present invention, a method for dynamically providing a securitized application for use in a mobile device is disclosed, comprising the steps of providing a computing system having elements for at least receiving and sending requests for mobile device applications and storing, reviewing and/or modifying and sending mobile device applications, operating the computing system to receive a request for a mobile device application from a mobile device and send the request to an application server. Further, the steps of the process include receiving the requested application from the application server by operation of the server and reviewing the received application with the computing system to either retrieve, from a storage associated with the computing system, a securitized version of the same application or modify the received application to create a securitized version of the application. Further, once created or found the method then sends, the securitized version of the application to the mobile device. In this way, when an application is desired the method of the present invention takes steps to either find a securitized version of the application or take the unsecured application and making it secure.

It will be seen that the method for providing a securitized application for use in a mobile device further comprising the steps of storing applications in a memory associated with the computing system and determining by computing whether the securitized version of the application is stored in the memory and if it is not creating a securitized version of the in response to the request for an application. In one embodiment, the method accomplishes its tasks by creating the securitized version of the application and then storing and reading the application in the computing system whereupon it can combine the stored application with securitized code to form a securitized version of the application. Securitized code, in the present invention, comprises, in one embodiment that is not meant to be limiting, implementations of a plurality of mobile security policies. In another embodiment the securitized code comprises restrictions of data selected from a group comprising, but not limited by: data access, data storage, and data encryption.

In addition, the method for providing a securitized application for use in a mobile device can include the step wherein the sending of the securitized version of the application to the mobile device comprises is done via a virtual private network. Further, the mobile device can be selected from a group comprising: an iOS® device (Apple®), an Android® device, and a Windows® phone device and that the application server can be selected from a group comprising: a server associated with iTunes®, a server associated with Google Play®, and a server associated with Windows Marketplace®.

In a further embodiment, the method of the invention can include the steps of receiving meta-data associated with the application from the application server, computing modified meta-data associated with the securitized version of the application and then sending the modified meta-data to the mobile device.

In the practice of the invention a computing system programmed by a computer-executable software code to dynamically deliver a securitized version of an application to a mobile device is provided. The computing system would have a memory configured to store a securitized version of an application and a processor coupled to the memory. In a preferred embodiment of the invention the processor is programmed to receive from the mobile device, a request for an application and then send the request for the application to an application server. Typically such servers receive requests and return the requested application; such that the computing system would receive the application from the application server. Once received, the system determines, through computation and review, what the securitized version of the application is, and then sends the securitized version of the application to the mobile device in preference to the requested non-modified application from the application server.

It will be understood that the processor can be further programmed to determine whether the securitized version of the application is otherwise stored in the memory of the computer system, such that it can produce and forward that to the mobile device, and if it is not so stored, the processor is programmed to create the securitized version of the application and then store the securitized version of the application in the memory so that the computer system can find it and forward it to the mobile device.

Using the computing system, it will be seen that a computer-implemented method for dynamically delivering a modified version of an application to a client device would be included therewith. The computing system would then receive a request from a client device for a download of an application from a remote server and as a result it would send a request for a download of the application to the remote server. Subsequently, it would receive the application from the remote server in response to the request for the download of the application and then create a modified version of the application which it would then send to the client device. Steps included in such a method could include creating the modified version of the application, storing and reading the application in the computing system and combining the stored application with a modified library to form the modified version of the application. It will be understood that the modified library would comprise computer code configured to either extend functionality of the application or restrict functionality of the application as desired or necessary. Persons having ordinary skill in the art of the present invention will recognize that the modified library can be selected from a group comprising: an encryption library, a security filter library, and a networking library without limiting the novel scope of the present invention.

In general then, the present invention relates to in-stream modification of downloaded applications or specialized programs for use with mobile devices. More specifically, embodiments of the present invention relate to modifying applications delivered to a client device, for example, without limitation, by securitizing the application. The present invention is particularly for use with client devices such as a mobile device for example a mobile telephone or an e-tablet, other computers, or the like.

Some embodiments of the present invention provide a modification security server disposed between a client such as a mobile device and a download source for an application such as an application store. In some specific embodiments, a client (for example, mobile, desktop device) communicates with an application store (such as iTunes®) or source via a modification or security server. In some embodiments, a VPN, SSL or other secure connection may be established between the client device and modification server to provide such functionality.

In some embodiments, the client device may be a mobile device: a portable phone, tablet computer, PDA, laptop; a stationary device: a desktop computer, a server, or the like. In some examples, the client device may be an iOS-based or OS-X device e.g. Apple iPhone®, Apple iPad®, iMac®; an Android®-based device e.g. Samsung® Galaxy®, Asus® Transformer®; a Windows®-based device e.g. Windows Phone®, Windows 7® (or 8) phones such as Nokia® Lumia®, Samsung® Slate®, desktop computer; or the like. The previous list is meant to be enlightening but not limiting as any number of devices can be used with the present invention without departing from the novel scope thereof. In some embodiments, the application store may be iTunes®; Google Play® or other Android® operating system store; Windows Marketplace® or other Windows-family such as Windows Phone operating system store; or the like.

In some embodiments, when there is an attempt to download an application on a device such as by a user clicking upon a link, or the like, the modification, for example, security server, will replace the application with a modified, in this case a securitized, version of the application. In some embodiments, the server may have a pre-stored modified version of an application such that when the user requests the application the server simply provides the secured modified version of the application to the mobile device instead of the unmodified version of the application. In other embodiments, the server may not have a stored modified version of the application, and thus the server must create the modified version of the application, on the fly or dynamically, such as when it is requested. In each of these situations, then, the modified version of the application will be provided to the device instead of the regular unmodified version of the application.

In some embodiments, the modified, that is securitized, version of the application is thus injected into the transaction between the device (mobile, desktop and application server or application store) without either party, the user or the application store, being inconvenienced.

In some embodiments, the modified (read securitized) version of an application is created by the modification (for example security) server, or the like, running the application; attaching a modified (read securitized) library of application programming interfaces calleds APIs; and packaging the result as a modified version of the application. In some embodiments, the modified library of APIs may include restrictions on functions called or used by the application or any other control of the interaction of the application. Examples of this may include, restrictions upon the user saving data to particular locations (that is preventing the user to save a file in the mobile device memory); restrictions upon where data may be accessed from (that is preventing upload or download from a cloud-based storage service Dropbox®, Box®, Google Drive®, or the like) and the like. Other types of modifications to the application may include: copy/paste restrictions, application file sharing restrictions, third party encryption support per application or per file, forcing an application to exit upon being moved from the foreground to the background, wiping data in memory, adding printing restrictions, adding authentication ability to applications, detecting “jail broken” devices, wiping data as soon as its freed, adding restrictions based upon specific location of the use, adding per application VPN or secure connection, adding per application IP address restrictions, adding or restricting accuracy to geographic location pinning and/or encryption of such data, destroying data, adding server based key encryption, adding logging into servers all calls/get analytics, adding the ability to place multiple policies on a device and switching operation of an application based on policy triggers even when offline, adding call home and receiving new policies from remote servers, restricting debugging modes, disabling of a camera or microphone, restricting access to particular address book/Calendar (for example allowing a device to retrieve non-corporate calendar data only), restricting “Open In” functionality, adding selective destroy on a per file/record basis, and the like.

According to some embodiments of the present invention, a security server is coupled to a mobile device via a VPN and an application store. However, in other embodiments, a security server may be generally termed a modification server, a VPN may be replaced by an unsecure connection, a secure connection, a VPN or SSL connection, or the like; the application store may be generally termed an application server; the mobile device may be any portable device or any stationary device, such as a desktop computer.

A more detailed explanation of the invention is provided in the following description and claims and is illustrated in the accompanying drawings.

Objects and advantages of the present invention will become apparent as the description proceeds.

### BRIEF DESCRIPTION OF THE DRAWINGS

FIG. 1 is a representation of a system using the method of the present invention; and

FIG. 2 is a flow chart of the functionality of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application “Detailed Description of an Illustrative Embodiment” relates to a requirement of the United States Patent Office, and should not be found to limit the subject matter disclosed herein.

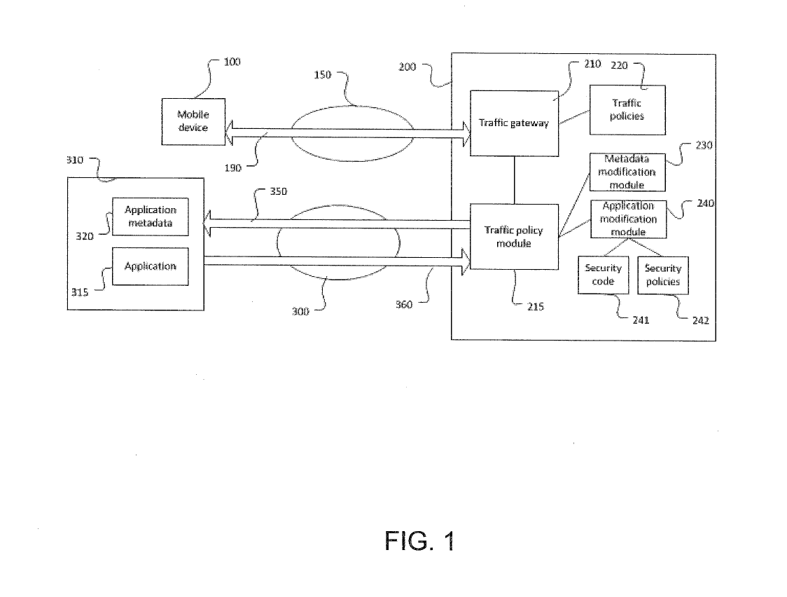

Referring to the drawings, FIG. 1 shows that a mobile device 100 connects via a communications network 150 such as the Internet, or a cellular network, for example, to the security inspection system 200. Mobile device traffic 190 is directed to the traffic gateway 210 within the security inspection system 200. The traffic gateway 210 passes the traffic to the traffic policy module 215. The traffic policy module 215 uses policies 220 to determine an action to take on the traffic. In situations where the mobile device 100 desires to access a mobile application “app store” 310 such as Google Play®, Apple AppStore®, etc., the traffic policy module 215 sends the traffic 350 to the app store 310. The app store 310 will return requested data 360 to the traffic policy module 215; the traffic will then be returned via the traffic gateway 210 back to the mobile device 100.

When mobile device 100 desires to download an application 315 from the app store 310, the process typically involves the mobile device 100 making a request for the application metadata 320. In this system, the traffic policy module 215 will send the request 350 to the app store 310 for the application metadata 320. The application metadata 320 will be returned 360 back to the traffic policy module 215. Then the traffic policy module 215 sends the application metadata 320 to the metadata modification module 230, where the metadata may be modified. The modified metadata is provided to the traffic policy module 215, where the modified metadata is sent through traffic gateway 210 back to mobile device 100. Next, the mobile device 100 will attempt to request the application 315. In this system, the traffic policy module 215 will send the request 350 to the app store 310 for the application 315. The application 315 will be returned 360 back to the traffic policy module 215. Then the traffic policy module 215 sends the application 315 to the application modification module 240, where the application will be modified to include/add into the application security code 241 and security policies 242. The modified application is provided to the traffic policy module 215, where the modified application is sent through traffic gateway 210 back to mobile device 100.

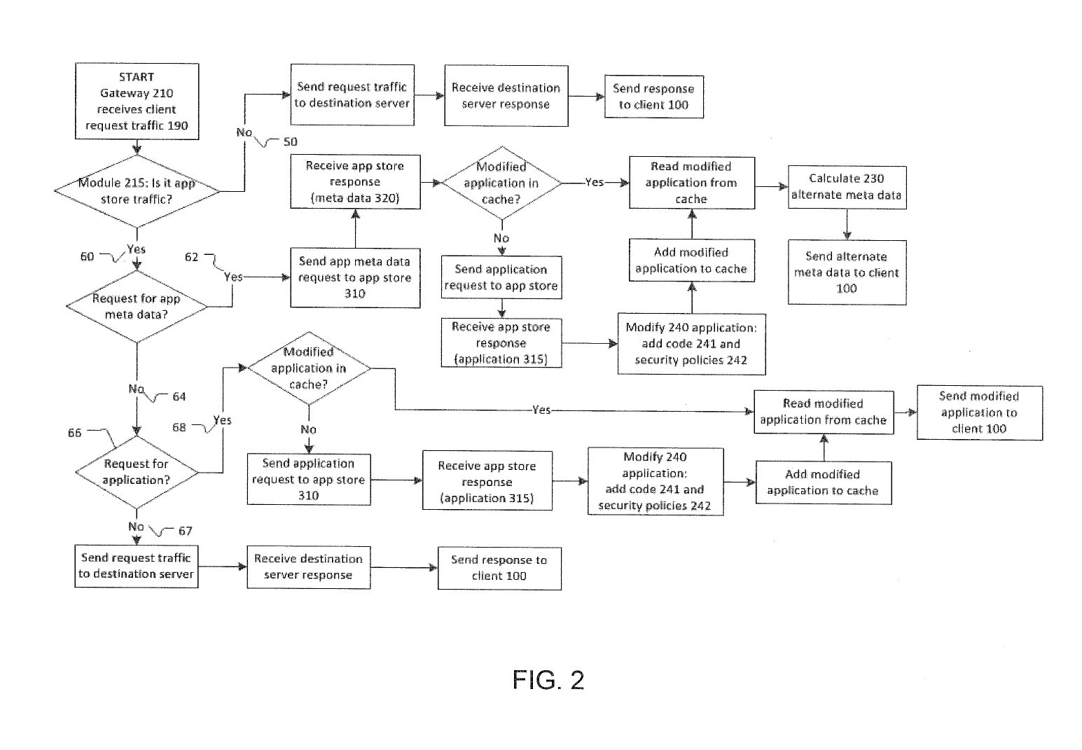

FIG. 2 is a flow chart of a preferred process of the security inspection system 200 of the present invention. It will be understood that the elements of the flow chart, FIG. 2, come from the elements illustrated and explained above with respect to FIG. 1, where necessary the elements of FIG. 1 will be noted in the description of the flow chart. It will be understood that other elements can be substituted by persons having ordinary skill in the art without departing from the novel scope of the present invention.

As illustrated, security inspection system 200, through gateway 210, receives client request traffic (which can be traffic related to an app store or otherwise). A review of FIG. 1 shows the various pathways and connections between security inspection system 200, application store 310 and the mobile device (or client) 100; including the structural pathways 190, 350 and 360 through the Internet (or cloud) 150, 300. Gateway 210 in conjunction with traffic policy module 215 channels the request in a manner consistent with the teachings of the present invention as shown in the following steps. If the traffic is not application store traffic 50, the security inspection system 200 sends the traffic to the destination server, receives a response to the query from the destination server, and reports the response to the client. If however, the traffic relates to a request for an application, that is, the request is app store traffic 60, the computing system 200, through gateway 210 will then determine if the request is for app meta-data 62 or not 64. Similar processes progress from the determination if the request is in regards to meta-data as will be discussed below.

If the gateway 210 determines that the request of the client is a request for meta-data 62, the request for app meta-data is forwarded to the app store 310. App store 310 provides traffic module 215 with the response to the query sent to the app store such that a determination as to whether there is a modified application copy readily available in cache or not. If there is a modified application available, then the modified date is read from cache and a calculation of the alternate meta-data is made and then sent to the client. If however, modified application copy is not available in cache, the application is received from the app store 310 and modified by the addition of additional code and security policies, in line with the teachings of the present invention. The modified application is then put into cache, where it is read, alternate meta-data is calculated and then the alternate data is sent to the client.

If the security inspection system 200 determines that the request of the client is not a request for meta-data 64, a determination is made as to whether the request is a request for an application 66. If the request is not a request for an application 67, then the request traffic is sent to the destination server and the response received therefrom is returned to the client. If the request is for an application 68, the security inspection system 200 checks to see if a modified application is available in cache and if so the application is read and reviewed and sent to the client 100. If there is no modified application in cache, the request for the application is sent to the app store and the app received from the app store as a result is modified in accordance with code and security policies 241, 242 to add additional security to the application. The modified application is then put into cache and in a further loop of the process the cached application is found and forwarded to the client 100.

The following is a real world-type example of the system broadly shown in FIG. 1:

1. A VPN or secure connection, or unsecure-connection connection is established between a mobile or stationary device and a security modification server. It will be understood that in some embodiments, the device may be a phone, tablet computer, PDA, laptop, computer, or the like and the security server may be associated with a company, organization, or the like.

2. A user using a mobile device connects to an application store via the VPN and the security server. The application store may be iTunes®, Google Play® or other Android® operating system store, Windows Marketplace® or other Windows-family e.g. Windows Phone operating system store.

3. The user selects an application from the application store for download via the VPN and security server.

4. The application store provides a meta-data of the application for download to the security server.

5. The security server determines a modified meta-data for a securitized version of the application.

6. The security server provides the modified meta-data to the mobile device via the VPN.

7. The mobile device provides a request for the binary executable of the application to the security server via the VPN.

8. The security server provides the request for the binary executable for the application to the application store.

9. The application store sends and the security server receives the binary executable for the application.

10. The security server determines a securitized version of the application.

11. The security server sends the securitized version of the application to the mobile device via the VPN. In one example, the following computer code may be used to provide the securitized version of the application.

12. The mobile device reviews the securitized version of the application and compares the computed meta-data to the modified meta-data provided in step 6.

13. When computed meta-data and modified meta-data match, the securitized version of the application is installed onto the mobile device.

In some embodiments of step 10, the following steps may be performed by the security server to determine a securitized version of the application:

1. Check memory to determine if a securitized version of the application has already been formed. If so, the securitized version of the application is provided to the mobile device.

2. If not, the security server unpacks the binary code of the application.

3. Next, a securitized library of functions is provided, and the binary code of the application and the securitized library of functions are repacked to form a securitized version of the application.

In some embodiments, meta-data may not be used to authenticate the download of an application. Accordingly, in such embodiments, the steps related to meta-data, described above, are not performed.

In other embodiments, combinations or sub-combinations of the above disclosed invention can be advantageously made. The block diagram of the architecture and the flow chart are grouped for ease of understanding. However it should be understood that combinations of blocks, additions of new blocks, re-arrangement of blocks, and the like are contemplated in alternative embodiments of the present invention.

As an example, in one embodiment, a user is coupled to a portable computer, desktop computer, or the like and attempts to download an application to their computer for their mobile device. In such an embodiment, the computer may again be coupled to the security server via a VPN to the application store. Similar to the above, when an application is being requested, the security server may intercept the response from the application store, and automatically provide the securitized version of the application back to the computer. Later, when the user synchronizes their mobile device to the computer, the securitized version of the application maybe provided to the mobile device.

Although an illustrative embodiment of the invention has been shown and described, it is to be understood that various modifications and substitutions may be made by those skilled in the art without departing from the novel spirit and scope of the invention.

What is claimed:

1. A method for providing a securitized application for use in a mobile device comprising the steps of:
providing a computing system having elements for at least receiving and sending requests for mobile device applications and storing, reviewing and/or modifying and sending mobile device applications;
operating the computing system to receive a request for a mobile device application from a mobile device and send the request to an application server;
receiving the requested application from the application server by operation of the server;
reviewing the received application with the computing system to either retrieve, from a storage associated with the computing system, a securitized version of the same application or modify the received application to create a securitized version of the application; and
sending, the securitized version of the application to the mobile device.

2. The method for providing a securitized application for use in a mobile device of claim 1, further comprising the steps of:
storing applications in a memory associated with the computing system;
determining by computing whether the securitized version of the application is stored in the memory;
determining by computing the securitized version of the application, when the securitized version of the application is not stored in the memory, in response to the request for an application.

3. The method for providing a securitized application for use in a mobile device of claim 2, further comprising the steps of:
creating the securitized version of the application by storing and reading the application in the computing system; and
combining the stored application with securitized code to form the securitized version of the application.

4. The method for providing a securitized application for use in a mobile device of claim 3 wherein the securitized code comprises implementations of computer logic to process a plurality of mobile security policies.

5. The method for providing a securitized application for use in a mobile device of claim 3 wherein the securitized code comprises restrictions of data selected from a group consisting: data access, data storage, and data encryption.

6. The method for providing a securitized application for use in a mobile device of claim 1 wherein the sending of the securitized version of the application to the mobile device comprises sending via a virtual private network.

7. The method for providing a securitized application for use in a mobile device of claim 1 wherein the mobile device is selected from a group comprising: an iOS device, an Android device, and a Windows phone device.

8. The method for providing a securitized application for use in a mobile device of claim 1 wherein the application server is selected from a group comprising: a server associated with iTunes®, a server associated with Google Play®, and a server associated with Windows Marketplace®.

9. The method for providing a securitized application for use in a mobile device of claim 1 further comprising the steps of:
receiving meta-data associated with the application from the application server;
computing modified meta-data associated with the securitized version of the application; and
sending the modified meta-data to the mobile device.

10. The method for providing a securitized application for use in a mobile device of claim 9 further comprising the steps of:
receiving a request for the application along with the modified meta-data from the application server; and
sending the request for the application along with the meta-data to the application server.

11. A computing system programmed with a computer-executable software code to dynamically deliver a securitized version of an application to a mobile device comprising:
a memory configured to store a securitized version of an application; and
a processor coupled to the memory, wherein the processor is programmed to receive from the mobile device, a request for an application, send the request for the application to an application server, receive the application from the application server, determine the securitized version of the application, and then send the securitized version of the application to the mobile device in preference to the requested non-modified application from the application server.

12. The computing system of claim 11 wherein the processor is further programmed to determine whether the securitized version of the application is otherwise stored in the memory and if it is not,
the processor is programmed to create the securitized version of the application and store the securitized version of the application in the memory.

13. A computer-implemented method for dynamically delivering a modified version of an application to a client device in a computing system comprising:
receiving a request from a client device for a download of an application from a remote server;
sending a request for a download of the application to the remote server;
receiving, the application from the remote server in response to the request for the download of the application;
creating a modified version of the application; and,
sending the modified version of the application to the client device.

14. The computer-implemented method of claim 13, wherein creating the modified version of the application comprises:
storing and reading the application in the computing system; and
combining the stored application with a modified library to form the modified version of the application.

15. The computer-implemented method of claim 14 wherein the modified library comprises computer code configured to extend functionality of the application.

16. The computer-implemented method of claim 14 wherein the modified library comprises computer code configured to restrict functionality of the application.

17. The computer-implemented method of claim 14 wherein the modified library is selected from a group comprising: an encryption library, a security filter library, and a networking library.
